(19) United States
(12) Patent Application Publication
(10) Pub. No.: US 2008/0037697 A1
(43) Pub. Date: Feb. 14, 2008

(54) Reproduction Time Measuring Circuit and Digital Data Reproducing Apparatus

(75) Inventors: Koichi Abe, Gunma-ken (JP); Junji Yamaguchi, Gunma-ken (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Osaka (JP); Sanyo Semiconductor Co., Ltd., Ora-gun (JP)

(21) Appl. No.: 11/835,180

(22) Filed: Aug. 7, 2007

(30) Foreign Application Priority Data
Aug. 8, 2006 (JP) 2006-215913

(51) Int. Cl. G07C 3/04

(52) U.S. Cl. 377/16

(57) ABSTRACT

A reproduction time measuring circuit for measuring a reproduction time of digital data sampled at a predetermined frequency, the circuit comprises: a count circuit configured to count a clock of the predetermined frequency while the digital data is stored in an output buffer configured to output the digital data in accordance with the clock; and a reproduction time signal output circuit configured to output a reproduction time signal indicating that the digital data has been reproduced for a time corresponding to the predetermined value, when a count value of the clock output from the count circuit reaches a predetermined value.

### CROSS-REFERENCE TO RELATED APPLICATION

This application claims the benefit of priority to Japanese Patent Application No. 2006-215913, filed Aug. 8, 2006, of which full contents are incorporated herein by reference.

### BACKGROUND OF THE INVENTION

1. Field of the Invention

The present invention relates to a reproduction time measuring circuit and a digital data reproducing apparatus.

2. Description of the Related Art

In accordance with provision of a music download service by way of Internet etc., a reproducing apparatus of compressed digital data of MP3 (MPEG Audio Layer-3) format etc. is beginning to find a widespread use. Such compressed digital data, different from data recorded on a music CD of CD-DA (Compact Disk Digital Audio) format, does not contain information for displaying a reproduction time of the digital data to the reproducing apparatus. Nor does such compressed digital data allow the reproduction time to be determined from the position within the digital data.

Accordingly, the compressed digital data reproducing apparatus measures the reproduction time by counting clocks used at the time of outputting the digital data after decoded to a PCM format etc. (for example, Japanese Patent Application Laid-Open Publication No. 2006-50362).

FIG. 6 is a diagram of a general configuration example of the compressed digital data reproducing apparatus. A reproducing apparatus 100 comprises an input buffer 110, a DSP (Digital Signal Processor) 111, a sampling clock generating circuit 112, and an output buffer 113. The input buffer 110 stores the compressed digital data (compressed audio data) of the MP3 format etc. The digital data stored in the input buffer 110 is decoded by the DSP 111 and thus decoded digital data (audio data) of the PCM format etc. is stored in the output buffer 113. The sampling clock generating circuit 112 generates a clock (sampling clock) corresponding to a sampling rate of the digital data stored in the output buffer 113. The output buffer 113 sequentially outputs the stored digital data in accordance with the clock output from the sampling clock generating circuit 112. The clock output from the sampling clock generating circuit 112 serves as an interrupt signal to the DSP 111 and the DSP 111 measures the reproduction time of the digital data in accordance with this interrupt signal.

FIG. 7 is a flow chart of a general example of reproduction time measuring processing in the DSP 111. The DSP 111, upon occurrence of the interrupt by the clock output from the sampling clock generating circuit 112, confirms whether the digital data is stored in the output buffer 113 (S701). When the reproducing is not being performed due to a temporary halt etc., the digital data is not present in the output buffer 113 and in such a case (S701: No), the DSP 111 ends the processing without renewing the reproduction time. If the digital data is present in the output buffer 113 (S701: Yes), then the DSP 111 adds one to a variable of the count value that starts with zero at the beginning of the reproducing (S702). Then, the DSP 111, by multiplying the count value by the time of one cycle of the sampling clock, calculates the reproduction time of the digital data (S703) and stores thus calculated reproduction time in a memory (S704). The reproduction time measured by the DSP 111 is output to a liquid crystal display etc. in response to a request from a microcomputer etc. external to the DSP 111.

As seen above, the reproducing apparatus 100 measures the reproduction time of the digital data by generating an interrupt to the DSP 111 for each cycle of the clock output from the sampling clock generating circuit 112 and this brings about an increased load to processing of the DSP 111. Though renewing of the reproduction time is not required when the digital data is not stored in the output buffer 113, the interrupt to the DSP 111 occurs even then and this interrupt as well contributes to the increased load to the processing of the DSP 111. Operating frequency of the DSP 111 is required to be lowered from now on for lower power consumption and noise suppression and it is important to reduce the load to the processing of the DSP 111.

### SUMMARY OF THE INVENTION

One aspect of the present invention is a reproduction time measuring circuit for measuring a reproduction time of digital data sampled at a predetermined frequency, the circuit comprising: a count circuit configured to count a clock of the predetermined frequency while the digital data is stored in an output buffer configured to output the digital data in accordance with the clock; and a reproduction time signal output circuit configured to output a reproduction time signal indicating that the digital data has been reproduced for a time corresponding to the predetermined value, when a count value of the clock output from the count circuit reaches a predetermined value.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram of a configuration example of a compressed audio reproducing apparatus as an embodiment of the present invention;

FIG. 2 is a diagram of a configuration example of a digital audio reproducing apparatus;

FIG. 3 is a diagram of a configuration example of a reproduction time measuring circuit;

FIG. 4 is a timing chart of an example of reproduction time measuring processing in the reproduction time measuring circuit;

FIG. 5 is a flow chart of an example of the reproduction time measuring processing in a DSP;

FIG. 6 is a diagram of a general configuration example of a compressed digital data reproducing apparatus; and

FIG. 7 is a flow chart of a general example of the reproduction time measuring processing in the DSP.

### DETAILED DESCRIPTION OF THE INVENTION

At least the following details will become apparent from descriptions of this specification and of the accompanying drawings.

==Configuration==

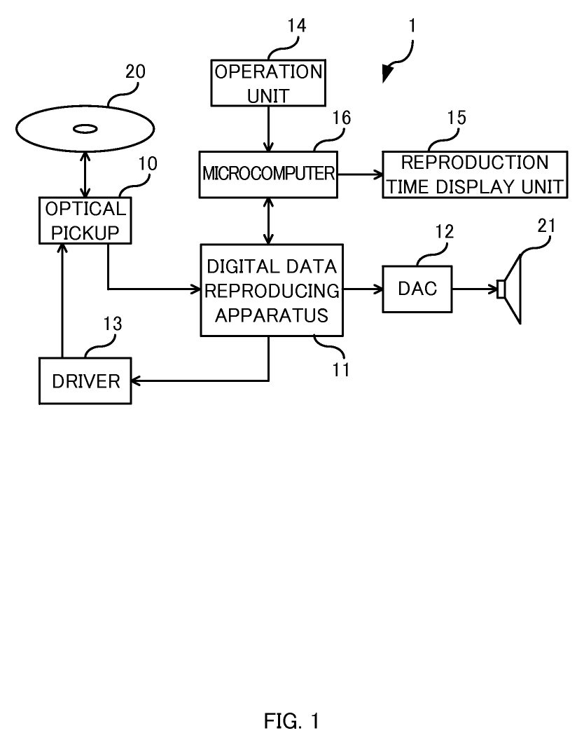

FIG. 1 is a diagram of a configuration example of a compressed audio reproducing apparatus as an embodiment of the present invention. A compressed audio reproducing apparatus 1, comprising an optical pickup 10, a digital data reproducing apparatus 11, a DA converter (DAC) 12, a driver 13, an operation unit 14, a reproduction time display unit 15, and a microcomputer 16, reads out compressed audio (digital data) recorded on a CD-ROM 20 and outputs the audio through a speaker 21.

The optical pickup 10 irradiates a laser light to a recording face of the CD-ROM 20, converts a reflected light thereof to an electric signal, and outputs it as an RF (Radio Frequency) signal.

The digital data reproducing apparatus 11, based on the RF signal output from the optical pickup 10, performs demodulation, error correction, etc. of the compressed digital data, generates a digital signal such as a PCM (Pulse Code Modulation) signal sampled at a predetermined frequency, and outputs it to the DAC 12. The digital data reproducing apparatus 11 measures a reproduction time of compressed audio (digital data) as reproduced and transmits thus measured reproduction time to the microcomputer 16 in response to a request therefrom. The digital data reproducing apparatus 11, based on the RF signal output from the optical pickup 10, performs servo processing for controlling the irradiation of the laser light from the optical pickup 10 to a recording medium 20 and outputs a control signal to the driver 13.

The DAC 12 converts the digital signal such as the PCM signal output from the digital data reproducing apparatus 11 to an analog signal and outputs it to the speaker 21. As a result, the compressed audio (digital signal) recorded on the recording medium 20 is output as the audio from the speaker 21.

The driver 13 performs a focusing control, a tracking control, etc. of the optical pickup 10, based on the control signals such as an FE (Focusing Error) signal and a TE (Tracking Error) signal output from the digital data reproducing apparatus 11.

The operation unit 14 is a unit for giving instructions such as a reproduction and a temporary halt is realized by selecting buttons, operating dials, etc.

The reproduction time display unit 15 is a unit for display of the reproduction time of the compressed audio (digital data) and is realized by an LCD (Liquid Crystal Display), an LED (Light Emitting Diode), etc.

The microcomputer 16, based on an input from the operation unit 14, transmits the instructions such as the reproduction of the compressed audio (digital data) and the temporary halt to the digital data reproducing apparatus 11. The microcomputer 16 receives the reproduction time of the compressed audio (digital data) from the digital data reproducing apparatus 11 and displays the received reproduction time on the reproduction time display unit 15.

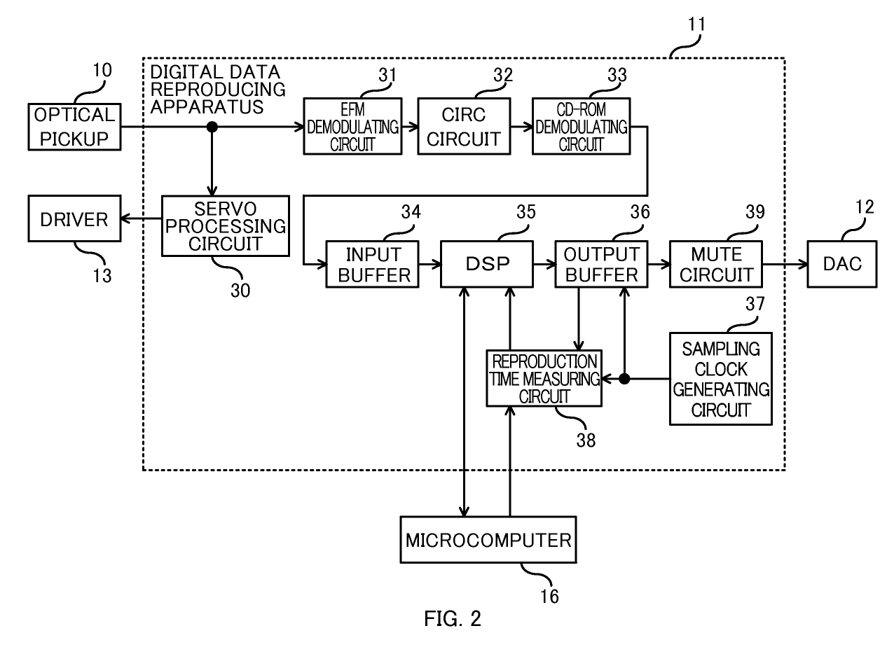

FIG. 2 is a diagram of a configuration example of the digital data reproducing apparatus 11. The digital data reproducing apparatus 11 comprises a servo processing circuit 30, and EFM (Eight to Fourteen Modulation) demodulating circuit 31, a CIRC (Cross-Interleaved Reed-Solomon Code) circuit 32, a CD-ROM demodulating circuit 33, an input buffer 34, a DSP 35, an output buffer 36, a sampling clock generating circuit 37, a reproduction time measuring circuit 38, and a mute circuit 39.

The servo processing circuit 30, based on the RF signal output from the optical pickup 10, generates the control signals such as the FE signal and the TE signal and output them to the driver 13.

The EFM demodulating circuit 31 binarizes the RF signal output from the optical pickup 10, converts it to the EFM signal, and demodulates the EFM signal for outputting.

The CIRC circuit 32 applies the error correction by the CIRC to the demodulated EFM signal output from the EFM demodulating circuit 31 and outputs thus error-corrected signal.

The CD-ROM demodulating circuit 33 performs CD-ROM demodulation of the error-corrected signal output from the CIRC circuit 32 and generates and outputs compressed digital data of an MP3 format etc.

The input buffer 34 is a temporary storage area for the digital data to be input to the DSP 35 and memorizes the compressed digital data output from the CD-ROM demodulating circuit 33.

The DSP 35 (digital data output unit) performs the demodulation of the compressed digital data of the MP3 etc. stored in the input buffer 34, noise canceling processing, equalizing processing, etc., and generates the digital signal such as the PCM signal sampled at the predetermined frequency. The DSP 35 adds a predetermined time (for example, one second) measured by the reproduction time measuring circuit 38 to the reproduction time of the digital data every time an interrupt signal is input from the reproduction time measuring circuit 38. The DSP 35 has its various functions realized by the processor's execution of a program stored in a memory.

The output buffer 36 is a temporary storage area for the digital data output from the DSP 35 and outputs the digital data in accordance with a clock of a sampling frequency output from the sampling clock generating circuit 37.

The sampling clock generating circuit 37 generates and outputs the clock of the sampling frequency (sampling clock) corresponding to the sampling rate of the digital data stored in the output buffer 36.

The reproduction time measuring circuit 38 counts the number of clocks output from the sampling clock generating circuit 37 while the digital data is stored in the output buffer 36, namely, while the digital data is being reproduced. Then, when the count value of the clocks reaches a predetermined value, the reproduction time measuring circuit 38 outputs the interrupt signal to the DSP 35. Namely, the reproduction time measuring circuit 38 outputs the interrupt signal (reproduction time signal) every time a predetermined time (for example, one second) elapses in terms of the reproduction time of the digital data. In the DSP 35, in accordance with the interrupt signal from the reproduction time measuring circuit 38, the predetermined time (for example, one second) is added to the reproduction time of the digital data. For example, when the frequency of the clock output from the sampling clock generating circuit 37 is 44.1 kHz, it can be so arranged that the reproduction time measuring circuit 38 will output the interrupt signal at the time when the count value of the clocks reaches 44100. In this case, the predetermined time to be measured at the reproduction time measuring circuit 38 is one second and the DSP 35 adds one second to the reproduction time of the digital data every time the interrupt signal is input from the reproduction time measuring circuit 38.

The mute circuit 39 is a circuit for putting the audio to be reproduced in a temporarily mute condition upon instruction from the DSP 35. Even while the audio is in the mute condition by the mute circuit 39, the digital data continues to be reproduced.

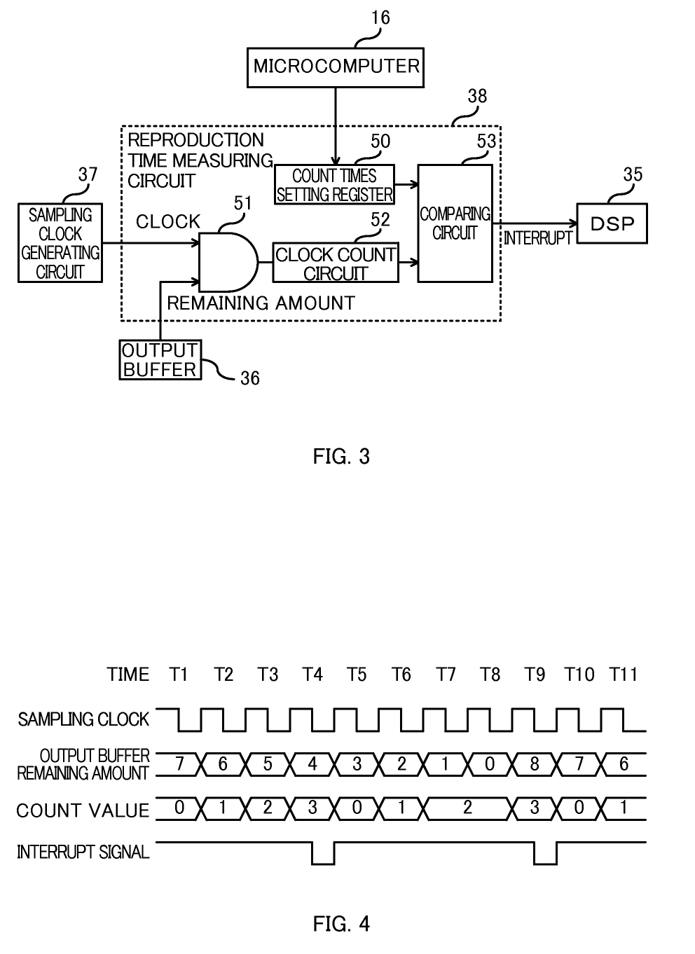

FIG. 3 is a diagram of a configuration example of the reproduction time measuring circuit 38. The reproduction time measuring circuit 38 comprises a count times setting register 50, an AND circuit 51, a clock count circuit 52, and a comparing circuit 53.

A predetermined value (number of count times) to be counted in the reproduction time measuring circuit 38 is set in the count times setting register 50 (memory circuit). This predetermined value can be changed by the control from the microcomputer 16.

The AND circuit 51 has inputs of the clock output from the sampling clock generating circuit 37 and of a signal indicating a remaining amount of the output buffer 36 output from the output buffer 36. In the present embodiment, it is assumed that the signal indicating the remaining amount of the output buffer 36 output from the output buffer 36 is at the High level when any digital data is in storage in the output buffer 36 and at the Low level when no digital data is in storage in the output buffer 36. Therefore, when no digital data is in storage in the output buffer 36, namely, when the digital data is not being reproduced due to the temporary halt etc., the output of the AND circuit 51 remains at the Low level. On the other hand, when any data is in storage in the output buffer 36, namely, when the digital data is being reproduced, the AND circuit 51 outputs the clock signal from the sampling clock generating circuit 37. The form of the signal indicating the remaining amount of the output buffer 36 is not limited to this, but any form may be acceptable so long as the storage or non-storage of the digital data can be determined. The circuit for changing the output signal depending on the storage or non-storage of the digital data can also be realized by a logic circuit other than the AND circuit 51.

The clock count circuit 52 counts the number of clocks input by way of the AND circuit 51. The clock count circuit 52 has an initial value of, for example, zero and adds one to the count value at the timing of the change of the clock output from the AND circuit 51, for example, from the Low level to the High level. The count value of the clock count circuit 52 is reset to the initial value (for example, zero) when the count value reaches the predetermined value set at the count times setting register 50. Namely, in the clock count circuit 52, counting from the initial value to the predetermined value is repeated.

The comparing circuit 53 outputs a signal of comparison between the predetermined value stored in the count times setting register 50 and the count value by the clock count circuit 52. When the predetermined value stored in the count times setting register 50 and the count value by the clock count circuit 52 are different, namely, when the count value has not reached the predetermined value, the comparing circuit 53 outputs a signal of one logic level (for example, High level). When the predetermined value stored in the count times setting register 50 and the count value by the clock count circuit 52 are same, namely, when the count value has reached the predetermined value, the comparing circuit 53 outputs a signal of the other logic level (for example, Low level). The signal to be output from the comparing circuit 53 when the count value has reached the predetermined value serves as the interrupt signal to the DSP 35. This interrupt signal can also be used for resetting the count value of the clock count circuit 52.

The AND circuit 51 and the clock count circuit 52 correspond to a count circuit of the present invention and the count times setting register 50 and the comparing circuit 53 correspond to a reproduction time signal output circuit of the present invention.

==Reproduction time Measuring Processing==

Description will then be made of reproduction time measuring processing. FIG. 4 is a timing chart of an example of the reproduction time measuring processing in the reproduction time measuring circuit 38. In the example of FIG. 4, it is assumed that the predetermined value set in the count times setting register 50 is “3” and that the initial value of the clock count circuit 52 is “0”. It is also assumed that the comparing circuit 53 outputs a High level signal when the predetermined value set in the count times setting register 50 and the count value of the clock count circuit 52 are different and a Low level signal when these two values are same.

Firstly, it is assumed that at time T1 the measurement starts in the reproduction time measuring circuit 38. Here, since the remaining amount of the digital data stored in the output buffer is “7” (7 samplings of data), the AND circuit 51 outputs the clock output from the sampling clock generating circuit 37. Therefore, as the time progresses, at each sampling, one piece of digital data is output from the output buffer 36, decreasing the buffer remaining amount, and at the same time, the count value of the clock count circuit 52 increases by one.

At time T4, when the count value of the clock count circuit 52 reaches “3” that is a value equal to the predetermined value set in the count times setting register 50, the signal output from the comparing circuit 53 changes from the High level to the Low level. Then, at time T5, when the count value of the clock count circuit 52 is reset to “0”, the signal output from the comparing circuit 53 changes from the Low level to the High level. This pulse signal generated by the comparing circuit 53 from time T4 to time T5 serves as the interrupt signal to the DSP 35. In response to this interrupt signal, the DSP 35 adds a predetermined time corresponding to the count value “3” in the clock count circuit 52 to the reproduction time. Namely, if the time of one cycle of the clock output from the sampling clock generating circuit 37 is given as T (second), Tx3 (second) is added to the reproduction time.

Thereafter, at each sampling, one piece of digital data is output from the output buffer 36, decreasing the buffer remaining amount, and at the same time, the count value of the clock count circuit 52 increases by one. Then, at time T8, the remaining amount of the digital data stored in the output buffer 36 comes to “0”. Namely, it comes to the situation where the digital data is not reproduced. As a result, the signal output from the AND circuit 51 is fixed at the Low level and the count value of the clock count circuit 52 remains to be “2”.

Then, at time T9, when the digital data is output from DSP 35 to the output buffer 36 and the remaining amount of the digital data stored in the output buffer 36 comes to “8”, the clock from the sampling clock generating circuit 37 is output from the AND circuit 51 and the count value of the clock count circuit 52 comes to “3”. Thereupon the signal output from the comparing circuit 53 changes from the High level to the Low level. Then, at time T10, when the count value of the clock count circuit 52 is reset to “0”, the signal output from the comparing circuit 53 changes from the Low level to the High level. This pulse signal generated by the comparing circuit 53 from time T9 to time T10 serves as the interrupt signal to the DSP 35 and the DSP 35 adds the predetermined time corresponding to the count value “3” to the reproduction time.

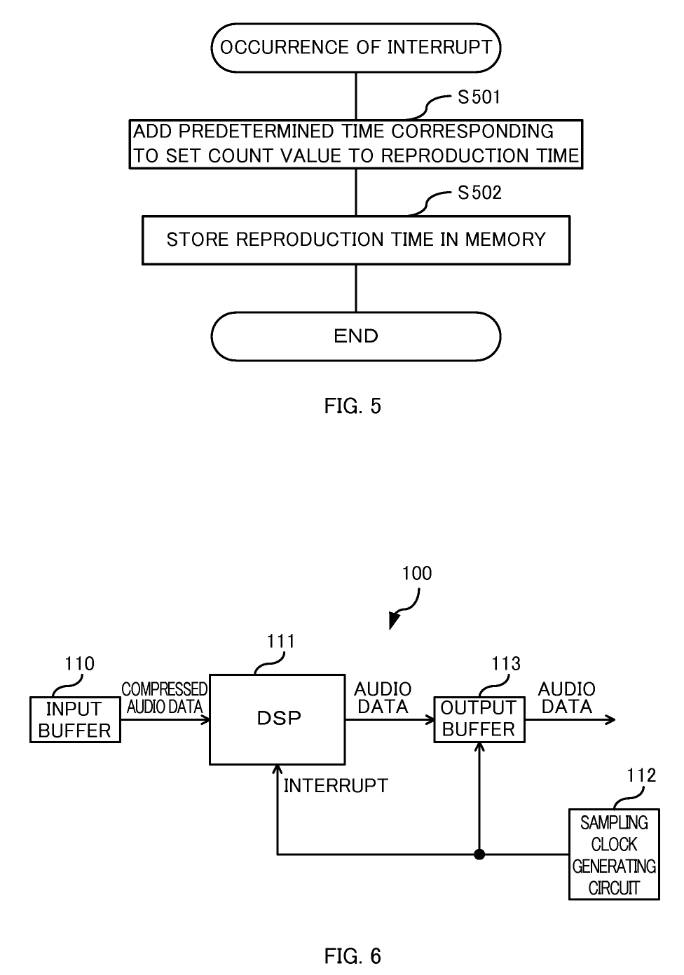

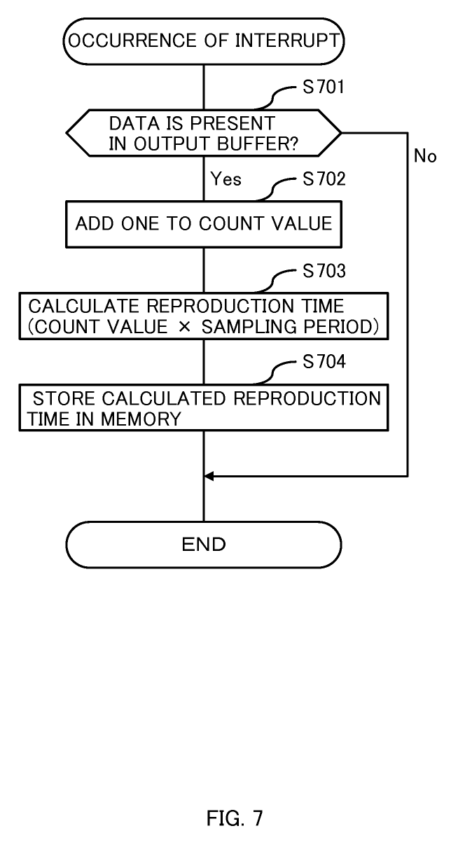

FIG. 5 is a flow chart of an example of the reproduction time measuring processing in the DSP 35. The DSP 35, upon receipt of the interrupt signal from the reproduction time measuring circuit 38, adds the predetermined time corresponding to the value (count value) set in the count times setting register 50 to the reproduction time (S501). Namely, in the example of FIG. 4, the predetermined time corresponding to the count value “3”, namely, Tx3 (second), is added to the reproduction time. Then, the DSP 35 stores thus calculated reproduction time in a memory (S502). The reproduction time stored in the memory is transmitted to the microcomputer 16 in response to a request therefrom and is displayed on the reproduction time display unit 15.

The above has described the embodiment of the present invention. As described above, by use of the reproduction time measuring circuit 38, the interrupt to the DSP 35 is generated for each predetermined time (for example, one second) as measured by the reproduction time measuring circuit 38 rather than for each cycle of the sampling clock. Namely, the number of interrupt times is reduced. There is no occurrence of the interrupt to the DSP 35 when no digital data is stored in the output buffer 36. This results in a reduced load to the processing of the DSP 35. A decrease in the number of steps of processing executed in the DSP 35 for the reproduction time measuring processing enables reduction of the amount of the memory required for storing the program.

The reproduction time measuring circuit 38 is provided with the count times setting register 50. The predetermined time to be measured by the reproduction time measuring circuit 38 can be changed by having the predetermined value set in the count times setting register 50 changed from the microcomputer 16. Therefore, for example, if the reproduction time is to be displayed in second on the reproduction time display unit 15 in the compressed audio reproducing apparatus 1, it can be achieved by setting the count value corresponding to one second in the count times setting register 50. For example, if the reproduction time is to be displayed in 0.1 second on the reproduction time display unit 15 in the compressed audio reproducing apparatus 1, it can be achieved by setting the count value corresponding to 0.1 second in the count times setting register 50. Namely, instead of causing the interrupt to constantly occur in a shortest possible time interval, the number of occurrences of the interrupt to the DSP 35 can be controlled to the number of occurrences according to the specification of the compressed audio reproducing apparatus 1 and the load to the processing of the DSP 35 can be reduced in accordance with the specification of the compressed audio reproducing apparatus 1. When the predetermined value set in the count times setting register 50 is changed, the reproduction time to be added in the DSP 35 is changed according to the predetermined value as changed.

The above embodiments of the present invention are simply for facilitating the understanding of the present invention and are not in any way to be construed as limiting the present invention. The present invention may variously be changed or altered without departing from its spirit and encompass equivalents thereof.

For example, while the CD-ROM 20 is used as a recording medium for compressed digital data in the present embodiment, the recording medium is not to be limited to this. For example, a DVD-ROM, a hard disk, a flash memory, etc., as well can be used. The compressed digital data to be reproduced is not limited to audio data, but may be video data.

It is claimed:

1. A reproduction time measuring circuit for measuring a reproduction time of digital data sampled at a predetermined frequency, the circuit comprising:
a count circuit configured to count a clock of the predetermined frequency while the digital data is stored in an output buffer configured to output the digital data in accordance with the clock; and
a reproduction time signal output circuit configured to output a reproduction time signal indicating that the digital data has been reproduced for a time corresponding to the predetermined value, when a count value of the clock output from the count circuit reaches a predetermined value.

2. The reproduction time measuring circuit of claim 1, wherein
the reproduction time signal output circuit includes:
a memory circuit configured to store the predetermined value; and
a comparing circuit configured to output the reproduction time signal when the count value of the clock output from the count circuit is equal to the predetermined value stored in the memory circuit.

3. A digital data reproducing apparatus comprising:
a clock generating circuit configured to generate a clock of a predetermined frequency;
a digital data output unit configured to output digital data sampled at the predetermined frequency;
an output buffer configured to store the digital data output from the digital data output unit and to output the digital data in accordance with the clock output from the clock generating circuit; and
a reproduction time measuring circuit configured to count the clock output from the clock generating circuit while the digital data is stored in the output buffer, and to output a reproduction time signal indicating that the digital data has been reproduced for a time corresponding to a predetermined value when a count value of the clock reaches the predetermined value,
the digital data output unit being configured to measure a reproduction time of the digital data, based on the reproduction time signal output from the reproduction time measuring circuit.

4. The digital data reproducing apparatus of claim 3, wherein
the reproduction time measuring circuit includes:
a memory circuit configured to store the predetermined value;
a count circuit configured to count the clock output from the clock generating circuit, while the digital data is stored in the output buffer; and
a comparing circuit configured to output the reproduction time signal when the count value of the clock output from the count circuit is equal to the predetermined value stored in the memory circuit.
